(19) United States
(12) Patent Application Publication
(10) Pub. No.: US 2007/0015025 A1
(43) Pub. Date: Jan. 18, 2007

(54) Membrane electrode assembly for solid polymer electrolyte fuel cell

(75) Inventors: Nagayuki Kanaoka, Saitama (JP); Masaru Iguchi, Saitama (JP); Hiroshi Sohma, Saitama (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/480,481

(22) Filed: Jul. 5, 2006

(30) Foreign Application Priority Data
Jul. 15, 2005 (JP) 2005-206278

(51) Int. Cl. H01M 8/10

(52) U.S. Cl. 429/33

(57) ABSTRACT

The present invention provides a membrane electrode assembly for solid polymer electrolyte fuel cells, which has superior hot water resistance, superior mechanical properties, superior power generating performance, and higher proton conductivity, even when a large number of sulfonic acid groups are introduced. The solid polymer electrolyte membrane has constitutional units expressed by the general formulas (1) and (2).

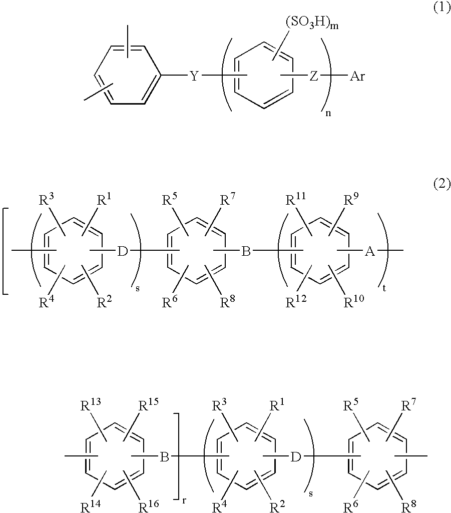

This application is based on and claims the benefit of priority from Japanese Patent Application No. 2005-206278, filed on 15 Jul. 2005, the content of which is incorporated herein by reference.

### BACKGROUND OF THE INVENTION

1. Field of the Invention

The present invention is related to membrane electrode assembly for solid polymer electrolyte fuel cells with a solid polymer electrolyte membrane formed from a sulfonated polyarylene polymer.

2. Related Art

Electrolytes are usually used in a solution, typically a water solution. However, in recent years, this continues to be replaced by increasing tendency to use electrolytes in a solid state. First, in processing instances, it is easily applied to electrical and electron materials. Second, it is lighter, more compact and converts into a reduction in power consumption.

The proton-conductive materials conventionally have an inorganic or organic compound. An example of the inorganic compound includes uranyl phosphate hydrate. However, in conductive layers that include this kind of inorganic compound, there are many problems forming the conductive layer on the electrode or substrate, since there is insufficient contact between a substrate and an electrode at a surface boundary.

On the other hand, an example of the organic compound includes a so-called cationic exchange polymer, such as sulfonated vinyl polymers such as polystyrene sulfonic acid, perfluoroalkyl sulfonic acid polymers such as Nafion (product name, by DuPont), perfluoroalkyl carboxylic acid polymers, and organic polymers of such heat resistant polymers as polybenzimidazole and polyetheretherketone having sulfonic or phosphoric group introduced therein (refer to Non-patent Documents 1 to 3).

These organic polymers are typically utilized in the form of a film of a solid polymer electrolyte membrane, with the advantages of thermoplasticity, or the solubility of a solvent, and can be processed so that a conductive membrane can be connected onto an electrode. However, most of these organic polymers suffer from problems such as insufficient proton conductivity, and in addition, at high temperatures (greater than 100 degrees C.) there are significant decreases in durability, proton conductivity, mechanical properties, and in particular elastic modulus, and significant fluctuations under humid conditions, insufficient adhesiveness to the electrodes, and a reduction in strength or a disintegration in shape caused by excessive swelling from a hydroscopic polymer structure. Therefore, there are varieties of problems in the organic polymers for applying to electrical or electron materials.

Furthermore, in Patent Document 1, a solid polymer electrolyte membrane is proposed that contains a rigid sulfonated polyphenylene. This polymer contains a phenylene chain which is produced by polymerizing an aromatic compound and introducing a sulfonic acid group through a reaction with a sulfonating agent. However, the organic polymers described above may provide higher proton conductivity with the amount additional of sulfonic acid groups is increased; however, there simultaneously arise problems in that mechanical properties of sulfonated polymers, for example, the toughness of breaking elongation and folding resistance, and hot water resistance, are remarkably impaired.

Patent Document 1: U.S. Pat. No. 5,403,675

Non-patent Document 1: Polymer Preprints, Japan, Vol. 42, No. 7, pp. 2490-2492(1993)

Non-patent Document 2: Polymer Preprints, Japan, Vol. 43, No. 3, pp. 736 (1994)

Non-patent Document 3: Polymer Preprints, Japan, Vol. 42, No. 3, pp. 730 (1993)

An object of the present invention is to provide a membrane electrode assembly for solid polymer electrolyte fuel cells, which has superior hot water resistance, superior mechanical properties, and superior power generating performance, and higher proton conductivity even when a larger number of sulfonic acid groups are introduced to increase ion exchange capacity.

### SUMMARY OF THE INVENTION

As a result of extensive research to achieve the objects, the inventors have found that the abovementioned problems are solved by providing a solid polymer electrolyte membrane which includes a sulfonated polyarylene with specific constitutional units.

According to a first aspect of the present invention, a membrane electrode assembly for solid polymer electrolyte fuel cells includes: an anode electrode; a cathode electrode; and a solid polymer electrolyte membrane, the anode electrode and the cathode electrode disposed on opposite sides of the solid polymer electrolyte membrane, in which the solid polymer electrolyte membrane has constitutional units expressed by the general formulas (1) and (2), which are shown below.

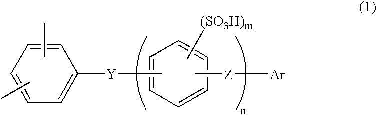

In the general formula (1), Y represents either of —CO— or —SO₂—; Z represents an oxygen or sulfur atom, or a direct bond; Ar represents a phenyl group or naphthyl group having an SO₃H group; where n is an integer of 1 or more; and m is an integer of 1 to 4.

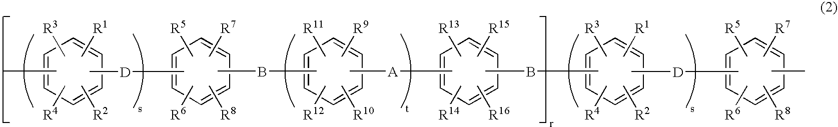

In the general formula (2), A and D each represents a structure independently selected from the group consisting of: a direct bond, —O—, —S—, —CO—, —SO₂—, —SO—, —CONH—, —COO—, —(CF₂)ᵢ— (i is an integer of 1 to 10), —(CH₂)ⱼ— (j is an integer of 1 to 10), —CR′₂— (R′ represents an aliphatic hydrocarbon group, aromatic hydrocarbon group, or halogenated hydrocarbon group), cyclohexylidene group, or fluorenylidene group; B represents independently an oxygen atom or sulfur atom; R¹ to R¹⁶, which may be identical or different from each other, represent at least one atom or group selected from a hydrogen atom, fluorine atom, alkyl group, partly or fully halogenated alkyl group, alkyl group, aryl group, nitro group and nitrile group; s and t are integers of 0 to 4; and r is an integer of 0 or more than 1.

According to a second aspect of the present invention, in the membrane electrode assembly for solid polymer electrolyte fuel cells, the constitutional unit expressed by the general formula (1) is expressed by the general formula (1a), which is shown below.

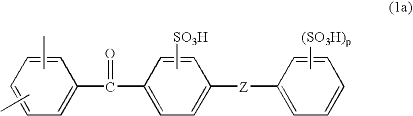

In the general formula (1a), Z represents an oxygen or sulfur atom, or a direct bond; and p is an integer of 1 or 2.

According to a third aspect of the present invention, in the membrane electrode assembly for solid polymer electrolyte fuel cells as described in the first aspect of the present invention, the sulfonated polyarylene includes a sulfonated polyarylene having an ion exchange capacity of 0.3 to 5 meq/g.

According to a fourth aspect of the present invention, in the membrane electrode assembly for solid polymer electrolyte fuel cells as described in the first aspect of the present invention, the sulfonated polyarylene includes a constitutional unit expressed by the general formula (1) in an amount of 10 to 99.999 mol %, and a constitutional unit expressed by the general formula (2) in amount of 0.001 to 90 mol %.

According to a fifth aspect of the present invention, in the membrane electrode assembly for solid polymer electrolyte fuel cells in the first aspect of the present invention, the sulfonated polyarylene has a weight average molecular weight of 10,000 to 1,000,000.

According to this invention, a solid polymer electrolyte, which containing superior hot water resistance, superior mechanical properties, higher proton conductivity and superior power generating performance, can be formed, even though the ion exchange capacity of the solid polymer electrolyte is increased.

### DETAILED DESCRIPTION OF THE INVENTION

The membrane electrode assembly for solid polymer electrolyte fuel cells according to the present invention will be explained more detail below. That is, the membrane electrode assembly for solid polymer electrolyte fuel cells according to the present invention is an electrode assembly having a solid polymer electrolyte membrane that contains a sulfonated polyarylene polymer.

Sulfonated Polyarylene

The sulfonated polyarylene polymer according to the present invention contains a constitutional unit expressed by the general formula (1) (hereinafter sometimes referred to as “constitutional unit (1)”) and a constitutional unit expressed by the general formula (2) (hereinafter sometimes referred to as “constitutional unit (2)”).

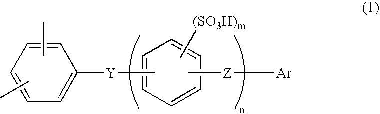

In the formula (1), Y represents —CO— or —SO₂—, preferably —CO—; Z represents an oxygen atom, sulfur atom or direct bond, which is preferably an oxygen atom or direct bond, and more preferably an oxygen atom; Ar represents a phenyl group or a naphthyl group with at least one SO₃H group, where n is an integer of 1 or more, preferably 1 to 2; and m is an integer of 1 to 4, preferably 1 or 2.

The constitutional unit (1) is preferably a constitutional unit expressed by the general formula (1a).

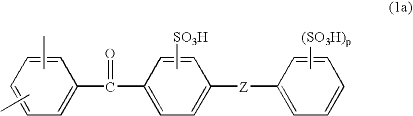

In the formula (1a), Z represents an oxygen atom, sulfur atom or direct bond, which is preferably an oxygen atom or direct bond, and more preferably an oxygen atom. p represents 1 or 2.

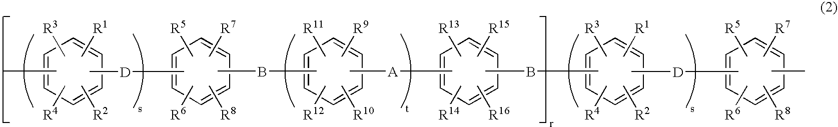

In the formula (2), A and D each represent structures, in which at least one of which has been selected independently from the group consisting of: a direct bond, —O—, —S—, —CO—, —SO₂—, —SO—, —CONH—, —COO—, —(CF₂)ᵢ— (i is an integer of 1 to 10), —(CH₂)ⱼ— (j is an integer of 1 to 10), —CR′₂— (R′ represents an aliphatic hydrocarbon group, aromatic hydrocarbon group, or halogenated hydrocarbon group), cyclohexylidene group, or fluorenylidene group; and among these, preferably a direct bond, —O—, —CO—, —SO₂—, —CR′₂—, cyclohexylidene group, and fluorenylidene group. Examples of R′ include methyl, ethyl, propyl, isopropyl, butyl, isobutyl, t-butyl, hexyl, octyl, decyl, octadecyl, ethylhexyl, phenyl, trifluoromethyl groups, or these substituents in which hydrogen atoms of these groups are partly or fully halogenated.

B independently represents an oxygen or sulfur atom, among these, an oxygen is preferred.

R¹ to R¹⁶, which may be identical or different from each other, represent at least one atom or group selected from a hydrogen atom, fluorine atom, alkyl group, partly or fully halogenated alkyl group, allyl group, aryl group, nitro group and nitrile group.

Examples of the alkyl groups include methyl, ethyl, propyl, butyl, amyl, hexyl, cyclohexyl and octyl groups. Examples of the halogenated alkyl groups include trifluoromethyl, pentafluoroethyl, perfluoropropyl, perfluorobutyl, perfluoropentyl and perfluorohexyl groups. An example of the allyl group includes a propenyl group; and examples of the aryl groups include phenyl and pentafluorophenyl groups.

s and t are integers of 0 to 4. r is an integer of 0 or more than 1, in which the upper limit is usually 100, and preferably 1 to 80.

An example of a preferred structure of the abovementioned constitutional unit (2) includes:

(i) s=1, t=1, A is —CR′₂—, a cyclohexylidene group or fluorenylidene group, B is an oxygen atom, D is —CO— or —SO₂—, and R¹ to R¹⁶ is a hydrogen or fluorine atom;

(ii) s=1, t=0, B is an oxygen atom, D is —CO— or —SO₂—, and R¹ to R¹⁶ is a hydrogen or fluorine atom; or

(iii) s=0, t=1, A is —CR′₂—, a cyclohexylidene group or fluorenylidene group, B is an oxygen atom, and R¹ to R¹⁶ is a hydrogen atom, fluorine atom or nitrile group.

A monomer or oligomer (hereinafter sometimes referred to as “compound 2′”) is synthesized for example, by referring to the method, described in Japanese Unexamined Patent Application Laid-Open No. 2004-137444.

Method for Producing Sulfonated Polyarylene

The sulfonated polyarylene of the present invention can be synthesized for example, by the method, described in Japanese Unexamined Patent Application Laid-Open No. 2004-137444.

Specifically, a sulfonic ester expressed by the general formula (1′), which is a precursor of the compound (1), and a compound expressed by the general formula (2′), which is a precursor of the compound (2); are first copolymerized by use of a catalyst to prepare a polyarylene having a sulfonic ester group; then the sulfonic ester group is de-esterified to convert it into a sulfonic acid group; and thereby a polyarylene having a sulfonic acid group is synthesized.

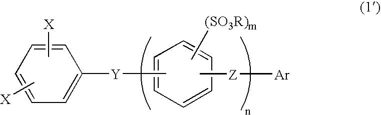

In the formula (1′), X represents an atom or group selected from the group consisting of a halogen atom other than fluorine, i.e., chlorine, bromine or iodine, —OSO₂CH₃ and —OSO₂CF₃, and preferably chlorine or bromine.

R independently represents a hydrocarbon group with 4 to 20 carbon atoms. Specifically, examples of R include linear hydrocarbon groups, branch hydrocarbon group groups, or alicyclic hydrocarbon groups, such as t-butyl, sec-butyl, isobutyl, n-butyl, n-pentyl, neopentyl, cyclopentyl, n-hexyl, cyclohexyl, heptyl, octyl, 2-ethylhexyl, cyclopentylmethyl, adamanthyl, cyclohexylmethyl, adamanthylmethyl, tetrahydrofurfuryl, 2-carbinylbutyl, 3,3-dimethyl-2,4-dioxolanemethyl, bicyclo[2.2.1]heptyl, and bicyclo[2.2.1]heptylmethyl groups. Preferably, the hydrocarbon group is a neopentyl, tetrahydrofurfuryl, cyclopentylmethyl, cyclohexylmethyl, adamanthylmethyl or bicyclo[2.2.1]heptylmethyl group, and more preferably a neopentyl group.

The meanings of Y, Z, Ar, m, and n are the same as those of Y, Z, Ar, m, and n in the formula (1).

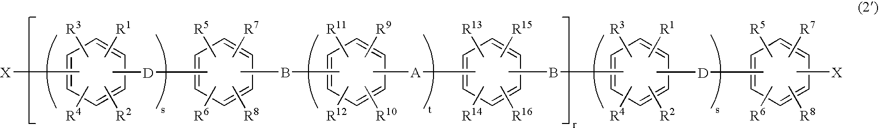

In the formula (2′), X represents an atom or group selected from the group consisting of a halogen atom other than fluorine, i.e., chlorine, bromine or iodine atoms, —OSO₂CH₃ and —OSO₂CF₃, in which chlorine or bromine are preferable. The meanings of A, B, D, R¹-R¹⁶, s, t, and r are the same as those of A, B, D, R¹-R¹⁶, s, t, and r in the formula (2).

The available catalysts used in the abovementioned polymerization contain a transition metal compound, in which the catalysts essentially contain: (i) a transition metal salt and a ligand compound (hereinafter sometimes referred to as “ligand component”), or a transition metal complex with a coordinate ligand (including copper salt); and (ii) a reducing agent, and additionally an optional “salt” in order to increase the polymerization reaction rate.

Specific examples of catalyst components, the usage ratio of each component, solvents, concentration, temperature, time period and the like in the reaction are illustrated in Japanese Unexamined Patent Application Laid-Open No. 2001-342241.

The ion-exchange capacity of the sulfonated polyarylene prepared in accordance with the methods described above is usually 0.3 to 5 meq/g, preferably 0.5 to 4 meq/g, and more preferably 0.8 to 3.5 meq/g. However, when the ion-exchange capacity is below the concentration range, the power generating performance tends to be insufficient due to lower proton conductivity, and when the ion-exchange capacity is above the concentration range, the water resistance may be remarkably degraded.

The ion-exchange capacity may be controlled, for example, by selecting the type, usage ratio and combination of the compounds (1′) and (2′). The sulfonated polyarylene in accordance with the present invention contain 0.5 to 100 mole %, preferably 10 to 99.999 mole % of the constitutional unit (1), and 0 to 99.5 mole % the constitutional unit (2), which is preferably 0.001 to 90 mole %.

The average molecular weight of the resulting sulfonated polyarylene is 10,000 to 1,000,000, preferably 20,000 to 500,000, and more preferably-30,000 to 300,000 based on polystyrene standard by way of gel permeation chromatography (GPC).

Electrode

Catalysts used in the present invention are preferably supported catalysts in which a platinum or platinum alloy is supported on a porous carbon material. Carbon blacks or activated carbons may be used for the porous carbon material. Examples of the carbon blacks include channel blacks, furnace blacks, thermal blacks, and acetylene blacks; and the activated carbons may be those produced through carbonizing and activating various carbon-containing materials.

Catalysts formed by supporting a platinum or platinum alloy on the carbon carrier may be used; and platinum alloys may offer stability and activity as electrode catalysts. Preferably, platinum alloys are used which are formed from platinum and at least one metal selected from platinum group metals other than platinum (i.e., ruthenium, rhodium, palladium, osmium and iridium), or metals of other groups such as cobalt, iron, titanium, gold, silver, chrome, manganese, molybdenum, tungsten, aluminum, silicon, rhenium, zinc and tin. The platinum alloys may include an intermetallic compound which is formed of platinum and other metals alloyable with platinum.

Preferably, the supported content of platinum or platinum alloys (i.e. mass % of platinum or platinum alloy on the basis of the overall mass of catalyst) is 20 to 80 mass %, and in particular 30 to 55 mass %, since this range in mass % may afford higher output power. However, when the supported content is less than 20 mass %, sufficient output power may not be attained, and when over 80 mass %, the particles of platinum or platinum alloys may not be supported on the carbon material with sufficient dispersibility.

The primary particle size of the platinum or platinum alloy is preferably 1 to 20 nm so as to obtain a highly active gas-diffusion electrode. In particular, the primary particle size is preferably 2 to 5 nm to ensure that the platinum or platinum alloy has a larger surface area from the viewpoint of reaction activity.

The catalyst layer in the present invention include, in addition to the abovementioned supported catalyst, an ion conductive polymer electrolyte or ion conductive binder that contains a sulfonic acid group. Usually, the supported catalyst is covered with the electrolyte, and thus protons (H+) travel through the pathway of the connecting electrolyte.

Perfluorocarbon polymers exemplified by Nafion (registered trademark), Flemion (registered trademark) and Aciplex (registered trademark) are appropriately used for an ion conductive polymer electrolyte containing a sulfonic acid group. An ion conductive polymer electrolyte based on an aromatic hydrocarbon compound such as the sulfonated polyarylene described in this specification may be used in place of the perfluorocarbon polymers.

Preferably, the ion conductive binder is included in a mass ratio of 0.1 to 3.0, preferably 0.3 to 2.0 in particular based on the mass of the catalyst particles. When the ratio of the ion conductive binder is less than 0.1, protons may not be conducted into the electrolyte, and thus possibly result in an insufficient power output. However, when the ratio is more than 3.0, the ion conductive binder may cover the catalyst particles completely, and thus gas cannot reach the platinum, resulting in insufficient power output.

A conjunction of membranes and electrodes according to the present invention may be formed solely of an anodic catalyst layer, a solid polymer electrolyte membrane, and a cathodic catalyst layer; more preferably, a gas diffusion layer formed of conductive porous material such as carbon paper and carbon cloth is disposed outside the catalyst layer along with the anode and cathode. The gas diffusion layer may act as an electric collector, and therefore, the combination of the gas diffusion layer and the catalyst layer is referred to as an “electrode” in this specification when the gas diffusion layer is provided.

In the solid polymer electrolyte fuel cell equipped with the conjunction of membranes and electrodes according to the present invention, oxygen-containing gas is supplied to the cathode and hydrogen-containing gas is supplied to the anode. Specifically, a separator having channels for the gas passage are disposed outside both electrodes, gas flows into the passage, and thereby the gas for fuel is supplied to the conjunction of membranes and electrodes. As described above, the conjunction of membranes and electrodes according to the present invention may yield highly effective power generation under lower humidity conditions in particular.

The method for producing the conjunction of membranes and electrodes may be selected from various methods: a catalyst layer is formed directly on an ion-exchange membrane and is sandwiched with a gas diffusion layer as required. A catalyst layer is formed on a substrate for a gas diffusion layer such as carbon paper, and then the catalyst layer is connected with an ion-exchange membrane and a catalyst layer is formed on a flat plate. A catalyst layer is transferred onto an ion-exchange membrane, the flat plate is peeled away, and then sandwiched with a gas diffusion layer as required.

The method for forming the catalyst layer may be selected from conventional methods: A supported catalyst and a perfluorocarbon polymer having a sulfonic acid group are dispersed into a medium to prepare dispersion. Optionally, a water repellent agent, pore-forming agent, thickener, diluent and the like are added to the dispersion. Then the dispersion is sprayed, coated or filtered on an ion-exchange membrane, gas-diffusion layer or flat plate. In cases in which a catalyst layer is not formed on an ion-exchange layer directly, the catalyst layer and the ion-exchange layer are preferably connected by means of a hot press or adhesion process, etc. (See Japanese Unexamined Patent Application Laid-Open No. 07 220741)

### EXAMPLES

The present invention will be explained more specifically with reference to Examples, which are not intended to limit the scope of the present invention. The methods or ways to determine various measurements in the Examples are also illustrated in the following.

Molecular Weight

Molecular weight of polymers was determined by GPC as the weight average molecular weight based on polystyrene standard. The solvent was N-methyl-2-pyrrolidone to which lithium bromide was added.

Ion Exchange Capacity

The resulting sulfonated polymer was washed with deionized water until the washed water became pH 4 to 6 so as to sufficiently remove free residual acid, and then was dried. The polymer was then weighed in a predetermined amount, dissolved into a mixture solvent of THF/water, and titrated with NaOH standard solution. The ion exchange capacity was determined from a neutral point.

Proton Conductivity

AC resistance was measured by platinum wires 0.5 mm in diameter being pushed onto a surface of a test membrane formed into a strip of 5 mm in width. The test membrane was disposed in a controlled temperature/humidity chamber and then AC impedance was measured between the platinum wires. The impedance was measured for AC 10 kHz under conditions of 85 degrees C. and a relative humidity of 90%. The measurements were performed by use of SI1260 Impedance Measuring System (by Solartron Corporation), and the controlled temperature/humidity chamber was Compact Environmental Testing Equipment SH-241 (by ESPEC Corp.). Five platinum wires were pushed onto the surface at an interval of 5 mm, the distance between the lines was varied within 5 to 20 mm, and AC resistance was measured. The specific resistance of membranes was then calculated from the slope of the relationship between the line distances and the resistances, and the proton conductivity was determined as the inverse value of the specific resistance.
Specific resistance R [ohm·cm]=0.5 (cm)×Membrane Thickness (cm)×Slope (ohm/cm)
Measurement of Tensile Strength

Tensile strength were determined in accordance with JIS K 7113 in which the pulling rate was 50 mm/min. The elongation was calculated in a way that the distance between markers were regarded as the distance between chucks. Test samples were conditioned at a temperature of 23±2 degrees C. and relative humidity (RH) 50±5 for 48 hours in accordance with JIS K 7113. The test samples were punched out by use of a number 7 dumbbell according to JIS K 6251. An “AGS-J Series Autograph” universal testing machine made by Shimazu Corporation, was used.

Hot Water Resistance

A film was cut into 2.0 cm by 3.0 cm sizes and weighed to prepare test pieces. The test pieces were disposed into a polycarbonate bottle of 250 ml, and distilled water of about 100 ml was added into the bottle. Then, the test pieces were heated at 120 degrees C. for 24 hours by use of a Pressure Cooker Tester (PC-242HS, by Hirayama MFS Corp.). After the hot water test, the test pieces were taken out of the hot water, dried in a vacuum dryer, and weighed to thereby determine the residual ratio of the weight.

Evaluation of Power Generation Property and Durability

A membrane electrode assembly according to the present invention were evaluated with respect to the power generating property under the conditions in which the temperature was 70 degrees C., the relative humidity was 70%/70% on a fuel electrode side/oxygen electrode side, and the current density was 1 A/cm². Pure hydrogen was supplied to the fuel electrode side, and air was supplied to the oxygen electrode side. The durability was evaluated under the power generating conditions in which the cell temperature was 105 degrees C., the current density was 0.5 A/cm², and the relative humidity was 70% on both the fuel electrode side and the oxygen electrode side, and afterwards the period up to cross-leak was reported. A durable generating period of 500 hours or more was considered to be superior and indicated as “satisfactory”, while the period of less than 500 hours was considered to be poor and indicated as “unsatisfactory”.

### Synthesis Example 1

50 g (145 mmol) of 2,5-dichloro-4′-phenoxybenzophenone were added into a 1 L three-necked flask, equipped with a cooling pipe, a three-way stopcock, a thermometer, and then purged with dry nitrogen gas. To the mixture, 263 g of chlorosulfonic acid was added and then dissolved by stirring. The reaction liquid was heated to 100 degrees C. while stirring for 10 hours. After the reaction, the reaction mixture was cooled to ambient temperature, and then was poured into ice water to extract an organic layer by ethyl acetate. The resulting organic layer was washed with brine until the pH of the solution became neutral, and then dried with magnesium sulfate to obtain 70 g of chlorosulfonated derivative.

70 g (130 mmol) of the resulting chlorosulfonated derivative and 72 g of pyridine was added into a 0.5 L three-necked flask, equipped with a cooling pipe, a three-way stopcock, and a thermometer, and then cooled to about 5 degrees C. To the mixture, 25 g (285 mmol) of 2,2-dimethyl-1-propanol 25 g (285 mmol) was gradually added, and then stirred in ice for 4 hours. After the reaction, the mixture was diluted and then washed twice in a hydrochloric acid water solution. Furthermore, the resulting organic layer was washed with 5% of sodium hydrogen carbonate water solution, processed with saturated water, and then dried with magnesium sulfate. The resulting material was recrystallized with methanol/hexane, and the intended product of 80 g was obtained. The resulting compound was the compound expressed by the formula (I) below.

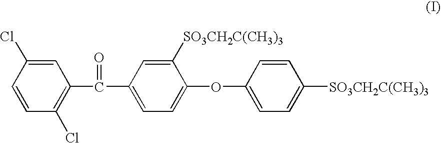

### Synthesis Example 2

31.7 g of 2,5-dichloro-4′-phenoxybenzophenone was added into a 100 ml three-necked flask equipped with a nitrogen inlet tube and a stirrer, and then cooled in an ice bath. 30 ml of concentrated sulfuric acid and 32 ml of 60% of fuming sulfuric acid were added into the mixture, and then stirred for 1 hour. The mixture was warmed to 70 degrees while being stirred for 15 hours. After the reaction solution was cooled, it was adjusted with a sodium hydroxide water solution until reaching the pH of 6 to 7, and then filtered. The filtrate was concentrated, and then extracted with 400 ml of dimethylsulfoxide. The insoluble matter in the reaction liquid was filtered, the filtrate was concentrated, the residue was dissolved in 60 ml of water, and then the solution was heated to 60 degrees C. Water was added into the solution unless precipitate is produced, and then the product was filtered to obtain 46.3 g of trisulfonated derivative.

90.9 g of trisulfonated derivative and 540 g of sulfolane was added into a 2 L three-necked flask equipped with a stirrer and a thermometer, a nitrogen inlet tube, a cooling pipe, and a tap funnel, and then cooled in an ice bath. 351 g of phosphorus oxychloride was slowly dropped into the mixture, and then stirred at 80 degrees C. for 2 hours. The reaction solution was added into ice water, and then the solution was extracted with ethyl acetate. Then, the solution was removed, recrystallized with ethyl acetate/n-hexane to obtain 45.4 g of sulfonic acid chloride.

31.9 g of sulfonic acid chloride, 13.2 g of neopentylalcohol and 70 g of pyridine were added into a 500 ml three-necked flask, equipped with a nitrogen inlet tube and a stirrer, and stirred at room temperature for 12 hours. The reaction solution was diluted with toluene, and washed twice with a hydrochloric acid water solution. Furthermore, the resulting organic layer was washed with a 5% sodium hydrogen carbonate water solution, and then dried with magnesium sulfate. The resulting material was recrystallized with methanol; thereby the 51.6 g of neopentylester expressed by the formula (II) below was obtained.

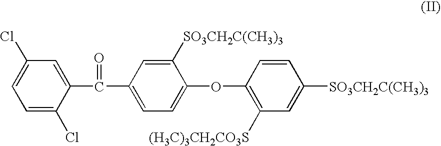

### Synthesis Example 3

3.3 g (10 mmol) of 2,5-dichloro-4′-phenylbenzophenon was added into a three-necked flask with a stirrer, and cooled. 4 ml of concentrated sulfuric acid and was added into the mixture to dissolve the product, and afterwards 4 ml of 60% of fuming sulfuric acid was added, and stirred at 80 degrees C. for 8 hours. The reaction solution was poured into 100 g of ice, neutralized with 10% of sodium hydroxide, and then the insoluble matter was filtered. The filtrate was concentrated, and then extracted with dimethylsulfoxide. The insoluble matter in the reaction liquid was filtered. The filtrate was concentrated, and then dried to obtain 4.7 g of disulphonated derivative.

280 g of disulphoned derivative and 280 g of sulfolane were added into a 1 L three-necked flask equipped with a stirrer and a thermometer, a cooling pipe, and a nitrogen inlet tube, and then cooled in an ice bath. 153 g of phosphorus chloride was slowly dropped into the mixture, and then heated to 80 degrees C. and stirred for 3 hours. The reaction solution was added into ice water. Afterwards, the solution was extracted, washed with sodium hydrogen carbonate water solution, and then the solvent was removed. The solvent was recrystallized with ethyl acetate/n-hexane to obtain 31.5 g of sulfonic acid chloride.

26.2 g of sulfonic acid chloride, 55 g of pyridine and 13.2 g of neopentylalcohol 13.2 g were added into a 500 ml three-necked flask equipped with a stirrer and a nitrogen inlet tube. The mixture was stirred for 8 hours, diluted with toluene, and washed with a hydrochloric acid water solution. Then, the solvent was removed, and recrystallized with ethyl acetate/n-hexane to obtain 26.4 g of sulfonic acid chloride expressed by the formula (III) below.

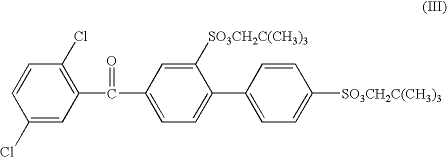

### Example 1

Preparation of Proton Conductive Membrane

49.7 g (77.3 mmol) of the product obtained from Synthesis Example 1, which is expressed by the formula (I), 30.5 g (2.7 mmol) of [4,4′-dichlorobenzophenone-2,2-bis(4-hydroxyphenyl)-1,1,1,3,3,3-hexafluoropropane]polycondensate that has a number average molecular weight of 11,200, 1.6 g (2.4 mmol) of bis(triphenylphosphine) nickel dichloride, 0.36 g (2.4 mmol) of sodiumiodide, 8.4 g (32 mmol) of triphenylphosphine and 12.6 g (192 mmol) of zinc were added into a 1 L three-necked flask equipped with a stirrer, a thermometer and a nitrogen inlet tube, and purged with dry nitrogen gas. 188 ml of N,N-dimethylacetamide (DMAc) was then added to the mixture, and the mixture was then stirred for 3 hours while keeping the temperature at 80 degrees C. Afterwards the reaction mixture was diluted with 200 ml of DMAc, and the insoluble matter was filtered.

The resulting filtrate was poured into a 3 L three-necked flask equipped with a stirrer, thermometer and nitrogen inlet tube, heated and stirred at 115 degrees C., and 20.1 g (232 mmol) of lithium bromide was added. The mixture was stirred for 7 hours, and then the reaction liquid was poured into 4 L of acetone to precipitate the product. The resulting product was rinsed with 1N HCl and deionized water, in order, and then dried to obtain the intended 61 g of sulfonated polymer. The polymer has an average molecular weight of about 145,000 and an ion exchange capacity of 2.2 meq/g; therefore, the polymer was presumed to be a sulfonated polymer expressed by the formula (IV).

The resulting sulfonated polymer was dissolved in N-methylpyrrolidone, and then a film having a thickness of 50 μm was prepared by casting the polymer onto PET. 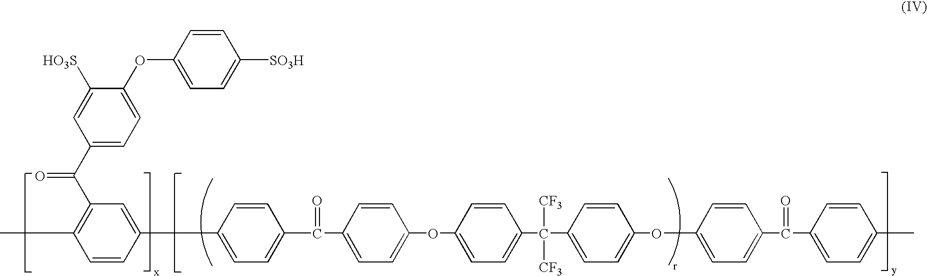
Preparation of Membrane electrode Assembly
i) Catalyst Paste

Platinum particles were supported onto a carbon black of (furnace black) having an average particle size of 50 nm at a weight ratio 1:1 of carbon black:platinum to thereby prepare catalyst particles. The catalyst particles were dispersed uniformly into a perfluoroalkylene sulfonic acid polymer compound (Nafion (product name), by DuPont) solution as an ion conductive binder in a weight ratio 8:5 of ion conductive binder:catalyst particles, thereby preparing a catalyst paste.

ii) Gas Diffusion Layer

The carbon black and polytetrafluoroethylene (PTFE) particles were mixed in a weight ratio 4:6 of carbon black:PTFE particles, and the resulting mixture was dispersed uniformly into ethylene glycol to prepare a slurry. Then the slurry was coated and dried on one side of carbon paper to form an underlying layer, and two gas diffusion layers, which were formed of the underlying layer and the carbon paper, were prepared.

iii) Preparation of Electrode-Coating Membrane (CCM)

To both sides of the proton conductive membrane, prepared in the example described above, the catalyst paste described above was coated by use of a bar coater in an amount in which the platinum content was 0.5 mg/cm², and was dried to prepare an electrode-coating membrane (CCM). During the drying step, a first drying at 100 degrees C. for 15 minutes was followed by a secondary drying at 140 degrees C. for 10 minutes.

iv) Preparation of Conjunction of Membranes and Electrodes

An assembly of membranes and electrodes was prepared in such a way that the CCM was gripped at the side of the underlying layer of the gas diffusion layer, and then was subjected to hot-pressing. During the hot-pressing step, a first hot-pressing at 80 degrees C. and 5 MPa for 2 minutes was followed by a second hot-pressing at 160 degrees C. and 4 MPa for 1 minute.

In addition, a solid polymer electrolyte fuel cell may be constructed from the membrane electrode assembly according to the present invention in such a way that a separator, being also usable as a gas passage, is laminated on the gas diffusion layer.

### Example 2

Preparation of Proton Conductive Membrane

57.9 g (77.3 mmol) of the product obtained from Synthesis Example 2, which is expressed by the formula (II), 53.4 g (7.1 mmol) of number average molecular weight 7,500 of (2,6-dichlorobenzonitrile-2,2-bis(4-hydroxyphenyl)-1,1,1,3,3,3-hexafluoropropane] polycondensate, 1.6 g (2.4 mmol) of bis(triphenylphosphine) nickel dichloride, 0.36 g (2.4 mmol) of sodiumiodide, 8.4 g (32 mmol) of triphenylphosphine and 12.6 g (192 mmol) of zinc were added into a 1 L three-necked flask, equipped with a stirrer, a thermometer and a nitrogen inlet tube, and purged with dry nitrogen gas. 260 ml of N,N-dimethylacetamide (DMAc) was added to the mixture, and the mixture was then stirred for 3 hours while keeping the temperature at 80 degrees C. Then the reaction mixture was diluted with 200 ml of DMAc and the insoluble matter was filtered.

The resulting filtrate was poured into a 3 L three-necked flask equipped with a stirrer, thermometer and nitrogen inlet tube, heated and stirred at 115 degrees C., and 22.8 g (263 mmol) of lithium bromide was added. The mixture was stirred for 7 hours, and then the reaction liquid was poured into 4 L of acetone to precipitate the product. The resulting product was rinsed with 1N HCl and deionized water, in that order, and then dried to obtain the intended 51 g of sulfonated polymer. The resulting polymer has a weight average molecular weight of 166,000 and an ion exchange capacity of 2.3 meq/g; therefore, the resulting polymer was presumed to be the sulfonated polymer expressed by the formula (V).

The resulting sulfonated polymer was dissolved into N-methylpyrrolidone, and then a film having a thickness of 50 μm was prepared by casting the polymer onto PET. 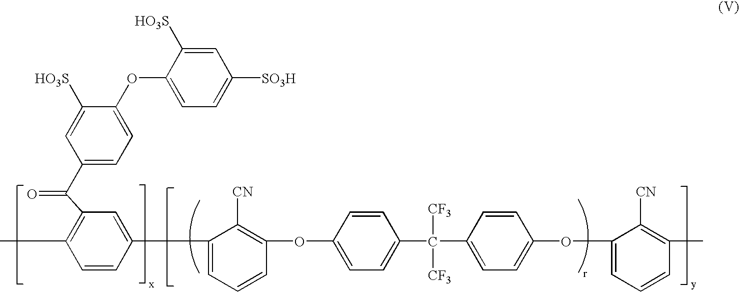
Preparation of Membrane Electrode Assembly

A membrane electrode assembly was prepared in the same manner as Example 1, except that the proton conductive membrane of Comparative Example 1 was employed.

### Example 3

Preparation of Proton Conductive Membrane

47.7 g (76.0 mmol) of the product obtained from Example 3, which is expressed by the formula (III), 30.0 g (4.0 mmol) of [4,4′-dichlorobenzonitrile-2,2-bis(4-hydroxyphenyl)-1,1,1,3,3,3-hexafluoropropane] polycondensate that has a number average molecular weight of 7,500, 1.6 g (2.4 mmol) of bis(triphenylphosphine) nickel dichloride, 0.36 g (2.4 mmol) of sodiumiodide, 8.4 g (32 mmol) of triphenylphosphine and 12.6 g (192 mmol) of zinc were added into a 1 L three-necked flask equipped with a stirrer, a thermometer and a nitrogen inlet tube, and purged with dry nitrogen gas. 180 ml of N,N-dimethylacetamide (DMAC) was added to the mixture, and the mixture was then stirred for 3 hours while keeping the temperature at 80 degrees C. Then the reaction mixture was diluted with 200 ml of DMAC and the insoluble matter was filtered.

The resulting filtrate was poured into a 3 L three-necked flask equipped with a stirrer, thermometer and nitrogen inlet tube, heated and stirred at 115 degrees C., and 15.8 g (182 mmol) of lithium bromide was added. The mixture was stirred for 7 hours, and the reaction liquid was poured into 4 L of acetone to precipitate the product. The resulting product was rinsed with 1N HCl and deionized water, in that order, and dried to obtain the intended 60 g of sulfonated polymer. The resulting polymer that has a weight average molecular weight of 156,000 and an ion exchange capacity of 2.3 meq/g; therefore, the resulting polymer was presumed to be the sulfonated polymer expressed by the formula (VI).

The resulting sulfonated polymer was dissolved in N-methylpyrrolidone, then a film having a thickness of 50 μm was prepared by casting the polymer onto PET. 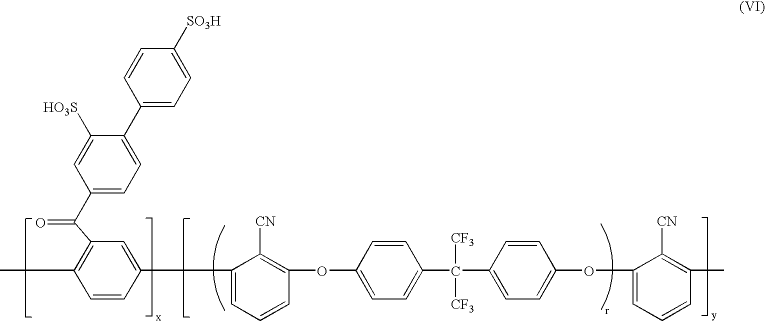
Preparation of Membrane Electrodes Assembly

An membrane electrode assembly was prepared in the same manner as Example 1, except that the proton conductive membrane of Example 3 was employed.

### Comparative Example 1

Preparation of Proton Conductive Membrane

50 g (145 mmol) of 2,5-dichloro-4′-phenoxybenzophenone were added into a 1 L three-necked flask equipped with a cooling pipe, a three-way stopcock, and a thermometer, and then purged with dry nitrogen gas. 263 g of chlorosulfonic acid was added to the mixture, and then stirred while keeping the mixture at less than 20 degrees C. for 3 hours. After the reaction, the reaction was poured into ice water to extract the organic layer by ethyl acetate. The resulting organic layer was washed with brine until the pH of the solution became neutral, and then dried with magnesium sulfate to obtain 60 g of chlorosulfonated derivative. The obtained compound was a monochlorosulfonated compound, which was different from the one in Example 1.

The resulting chlorosulfonated derivative and 75 g of pyridine was added into a 0.5 L three-necked flask equipped with a cooling pipe, a three-way stopcock, and a thermometer, and then cooled to about 5 degrees C. 13.2 g (149 mmol) of 2,2-dimethyl-1-propanol was gradually added to the mixture, and then stirred in ice for 4 hours. After the reaction, the mixture was diluted and then washed twice in a hydrochloric acid water solution. Furthermore, the resulting organic layer was washed with a 5% sodium hydrogen carbonate water solution, processed with saturation water solution, and then dried with magnesium sulfate. The organic layer was recrystallized with methanol/hexane, to obtain the intended product of 60 g. The resulting compound was the compound expressed by the formula (VII) below.

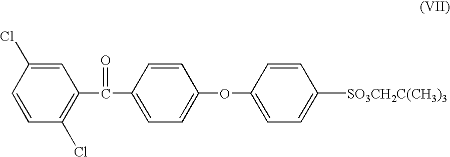

78.1 g (121 mmol) of the obtained product expressed by the formula (VII), 47.8 g (4.3 mmol) of [4,4′-dichlorobenzophenone-2,2-bis(4-hydroxyphenyl)-1,1,1,3,3,3-hexafluoropropane] polycondensate that has a number average molecular weight of 11,200, 2.5 g (3.8 mmol) of bis(triphenylphosphine) nickel dichloride, 0.56 g (3.8 mmol) of sodiumiodide, 13.2 g (50.2 mmol) of triphenylphosphine and 19.7 g (301 mmol) of zinc were added into a 1 L three-necked flask equipped with a stirrer, a thermometer and a nitrogen inlet tube, and purged with dry nitrogen gas. 295 ml of N,N-dimethylacetamide (DMAC) was added to the mixture, and the mixture was then stirred for 3 hours while keeping the temperature at 80 degrees C. Then the reaction mixture was diluted with 300 ml of DMAc and the insoluble matter was filtered.

The resulting filtrate was poured into a 3 L three-necked flask equipped with a stirrer, thermometer and nitrogen inlet tube, heated and stirred at 115 degrees C., and 31.6 g (364 mmol) of lithium bromide was added. The mixture was stirred for 7 hours, and then the reaction liquid was poured into 5 L of acetone to precipitate the product. The resulting product was rinsed with 1N HCl and deionized water, in that order, and then dried to obtain the intended sulfonated polymer of 90 g. The resulting polymer has a weight average molecular weight of 145,000 and an ion exchange capacity of 2.2 meq/g; therefore, the resulting polymer was presumed to be the sulfonated polymer expressed by the formula (VIII). 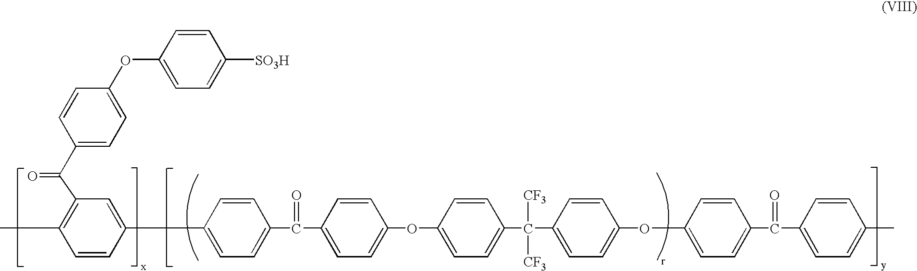
Preparation of Membrane electrode Assembly

A membrane electrode assembly was prepared in the same manner as Example 1, except that the proton conductive membrane of the Comparative Example 1 was employed.

Evaluation

The solid polymer electrolyte membranes obtained from Examples 1 to 3, and Comparative Example 1 were evaluated with respect to proton conductivity, tensile strength, tensile elongation, and hot water resistance. In addition, membrane electrode assembly was produced, and then evaluated with power generation performance and the durability. The results are summarized in Table 1.

TABLE 1

| | Example 1 | Example 2 | Example 3 | Comparative Example 1 |
|---|---|---|---|---|
| Ion-Exchange Capacity [meq/g] | 2.2 | 2.3 | 2.2 | 2.2 |
| Proton Conductivity [S/cm] | 0.27 | 0.31 | 0.3 | 0.25 |
| Tensile Strength [Mpa] | 145 | 138 | 139 | 148 |
| Tensile Elongation [%] | 45 | 63 | 49 | 5 |
| Hot Water Resistance Weight Retention (%) | 100 | 100 | 100 | 74 |
| Power Generating Performance (V) | 0.635 | 0.642 | 0.638 | 0.629 |
| Power Generating Durability | satisfactory | satisfactory | satisfactory | unsatisfactory |

According to the Examples, a sulfonated polyarylene with a particular structure can increase the ion exchange capacity to enhance the proton conductivity. In addition, even if the sulfonated polyarylene increases the ion exchange capacity, it can have superior tensile elongation, higher toughness, and higher hot water resistance. Furthermore, the proton conductive membranes according to the present invention may yield a membrane electrode assembly that displays excellent power generating properties and higher thermal resistance.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A membrane electrode assembly for solid polymer electrolyte fuel cells, comprising: an anode electrode; a cathode electrode; and a solid polymer electrolyte membrane, the anode electrode and the cathode electrode are disposed on opposite sides of the solid polymer electrolyte membrane,
wherein the solid polymer electrolyte membrane has a sulfonated polyarylene having constitutional units expressed by the general formulas (1) and (2) shown below: 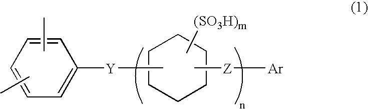
in which Y represents either —CO— or —SO₂—; Z represents an oxygen or sulfur atom, or a direct bond; Ar represents a phenyl group or naphthyl group having an SO₃H group; n is an integer of 1 or more; m is an integer of 1 to 4; and 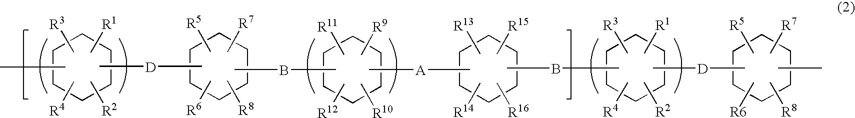
in which A and D each represents at least one structure selected independently from the group consisting of a direct bond, —O—, —S—, —CO—, —SO₂—, —SO—, —CONH—, —COO—, —(CF₂)ᵢ— (i is an integer of 1 to 10), —(CH₂)ⱼ— (j is an integer of 1 to 10), —CR′₂— (R′ represents a aliphatic hydrocarbon group, aromatic hydrocarbon group, or halogenated hydrocarbon group), cyclohexylidene group, or fluorenylidene group; B represents independently an oxygen atom or sulfur atom; R¹ to R¹⁶, which may be identical or different from each other, represent at least one atom or group selected from a hydrogen atom, fluorine atom, alkyl group, partly or fully halogenated alkyl group, allyl group, aryl group, nitro group and nitrile group; s and t are integers of 0 to 4; and r is an integer of 0 or more than 1.

2. The membrane electrode assembly for the solid polymer electrolyte fuel cell according to claim 1, wherein the constitutional unit expressed by the general formula (1) is expressed by the general formula (1a) shown below: 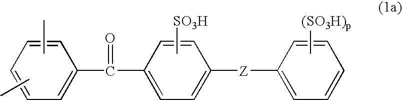
in which Z represents an oxygen or sulfur atom, or a direct bond; p is an integer of 1 or 2.

3. The membrane electrode assembly for the solid polymer electrolyte fuel cell according claim 1, wherein the sulfonated polyarylene includes an ion exchange capacity of 0.3 to 5 meq/g.

4. The membrane electrode assembly for solid polymer electrolyte fuel cells according to claim 1, wherein the sulfonated polyarylene includes the constitutional unit expressed by the general formula (1) in an amount of 10 to 99.999 mol %, and the constitutional unit expressed by the general formula (2) in amount of 0.001 to 90 mol %.

5. The membrane electrode assembly for the solid polymer electrolyte fuel cell according to claim 1, wherein the solid polymer electrolyte membrane includes a sulfonated polyarylene having a weight average molecular weight of 10,000,000.
